(19) United States
(12) Patent Application Publication
(10) Pub. No.: US 2006/0098649 A1
(43) Pub. Date: May 11, 2006

(54) SYSTEM, APPARATUSES, METHODS, AND COMPUTER-READABLE MEDIA FOR DETERMINING SECURITY REALM IDENTITY BEFORE PERMITTING NETWORK CONNECTION

(75) Inventor: A. David SHAY, Lawrenceville, GA (US)

Correspondence Address: SMITH FROHWEIN TEMPEL GREENLEE BLAHA, LLC, P.O. BOX 88148, ATLANTA, GA, 30356, US

(73) Assignee: TRUSTED NETWORK TECHNOLOGIES, INC., Alpharetta, GA (US)

(21) Appl. No.: 11/164,085

(22) Filed: Nov. 9, 2005

Related U.S. Application Data
(60) Provisional application No. 60/626,578, filed on Nov. 10, 2004.

(51) Int. Cl. H04L 12/56

(52) U.S. Cl. 370/389; 370/401

(57) ABSTRACT

An embodiment of a system of the invention includes a request node, an enforcement node, and a resource node. A request node generates a packet requesting access to a resource, includes its security realm identifier in the packet header, and transmits the same to the enforcement node via a network such as the Internet. The enforcement node receives the packet and applies the security policy of the resource node based on whether or not the request node is in the same security realm as the resource node. Related apparatuses, methods, and computer-readable media are also disclosed and claimed.

### CROSS-REFERENCE TO RELATED APPLICATIONS

This patent application is a U.S. nonprovisional application filed pursuant to Title 35, United States Code §100 et seq. and 37 C.F.R. Section 1.53(b) claiming priority under Title 35, United States Code § 119(e) to U.S. provisional application No. 60/626,578 filed Nov. 10, 2004 naming A. David Shay as the inventor, which application is herein incorporated by reference. Both the subject application and its provisional application have been or are under obligation to be assigned to the same entity.

### BACKGROUND OF THE INVENTION

This invention relates to security in network communications, and more particularly, to a system, apparatuses, methods, and computer-readable media that can be used for secure communications for computers of different security realms.

In computer networks, security policy can be implemented on the basis of a ‘security realm’ which includes users, user groups, and access control lists which define the resources (services, applications, data, etc.) that each user or user group is permitted to access via a computer network. Normally, a security realm is defined at the level of an organization or company, but it can be defined at more specific levels such as group, department, or division within an organization, or at more general levels such as groups of organizations.

Regardless of the definition of the entity to which a security policy is applied, an entity usually applies security policy differently depending upon whether the user or system initiating a communication to request access to a resource is a member or non-member of the entity receiving the communication. For entities having only a single computer or group of computers connected in a single local area network (LAN) with connectivity to the Internet through a gateway computer and firewall, with no remote users or systems, it is relatively straightforward to determine that communications originating from users and systems from the public network or Internet side of the firewall are not within the security realm of the protected computer or network. However, for many entities having remote users or distributed networks or computers connected via a wide area network (WAN) or the Internet, determination whether a user or system originating a communication belongs to a security realm cannot be made unless a transmission control protocol/Internet protocol (TCP/IP) connection or other network connection is established, and identifying username/password, credentials, certificates, etc. are exchanged between nodes. However, once a connection is established, an attacker already has a level of access to a computer network. The attacker can exploit this network connection to obtain unauthorized access to network resources. Alternatively, an attacker can execute another form of attack, such as the introduction of computer code such as a virus or worm into the computer network. From financial and legal liability standpoints, the costs of such unauthorized access to network resources can be substantial. This is particularly true in cases in which confidential commercial or personal information has been accessed by the attacker. In these cases, the harm done to the company cannot be remedied because once the confidential status of business information and data is lost, it is very difficult if not impossible to undue the fact that the information is publicly known. Moreover, if such data is of a type that is protected by privacy laws, the business owner may be forced to establish that the measures taken to insure network security were reasonable under the circumstances in spite of the attack. In addition, the loss of confidential information may cause a loss of confidence on the part of the business owner's customers. The economic costs of virus and worm outbreaks and their impact on businesses worldwide are well-known and documented. For example, the economic damage done to computer users by the Goner, Code Red II, Blaster, SoBig, Netsky and Sasser worms and viruses was very significant. In each outbreak, the impact worldwide amounted to millions or billions of US dollars in damage due to lost productivity and costs to resolve the consequences of these worms and viruses. Clearly, it would be desirable to provide an invention with the capability to be able to determine whether a user or system requesting a network connection is inside or outside of the security realm of the entity receiving the connection request, before permitting connection with such originating user or system. This would greatly reduce exposure of systems, users, and resources to attacks such as those described above.

### BRIEF SUMMARY OF THE INVENTION

The disclosed system, apparatuses, methods, and computer-readable media, in one or more of the embodiments disclosed and claimed, overcome one or more of the above-mentioned problems, and achieve additional advantages as hereinafter set forth.

A method of a first embodiment of the invention comprises, at a first node, including a realm identifier identifying a security realm of the first node into a header of a packet requesting access to a resource. The method can further comprise transmitting the packet including the realm identifier from the first node to the second node hosting the resource via a network. The method can further comprise receiving the packet at the second node, comparing the realm identifier from the packet header with a realm identifier of the second node, and applying security policy to the packet to control access to the resource based on the comparing of the realm identifiers. The network carrying the packet from the first node to the second node can be the Internet. The realm identifier can be included in an Internet Protocol (IP) header of the packet. More specifically, the realm identifier can be included in a transmission control protocol/Internet protocol (TCP/IP) SYN packet for initiating a network connection. The method can further comprises steps of encrypting data identifying the first node and a user of the first node using a key, including the encrypted data in at least one field of the header of the packet, and including the index identifying the key in an additional field of the packet header. For example, the data identifying the first node and the user of the first node can be included in the sequence number and acknowledgement number fields of a transmission control protocol (TCP) portion of the header of the packet, and the index can be included in the urgent pointer field of the TCP portion of the packet header. The method can further comprise the step of appending the index to the data identifying the user of the first node before encrypting the data. This permits the receiving node to confirm that the network connection requested by the packet has not been hijacked by confirming that the exposed and encrypted indexes are the same. The method can further comprise generating the packet at the first node so that the node generating the packet and including the realm identifier in the packet are the same node (thus, the node generating the request packet and the node inserting the realm identifier into the request packet need not be the same). The requested resource can be data or a program that is either directly or indirectly designated by the request.

A method of a second embodiment of the invention comprises, at a first node, receiving a request to access a resource from an application running on the first node; retrieving a realm identifier of the first node; including the realm identifier in a header of a packet; and releasing the packet for transmission to a second node enforcing security policy for access to the resource. The resource can be data for which access is sought, or a program to be executed. The first node can be, and normally is, a computer of some kind, e.g., a personal computer or server. The packet in which the realm identifier is included can be a transmission control protocol/Internet protocol (TCP/IP) packet, or more specifically, a TCP/IP SYN packet. The method can further comprise the step of transmitting the packet from the first node to the second node via a network, which can be the Internet.

A method of a third embodiment of the invention comprises the steps of, at a first node, receiving a packet having a header with a realm identifier of a second node originating the request, and including a request to access a resource; retrieving a realm identifier of a third node hosting the resource; comparing the realm identifier of the second node generating the request with the realm identifier of the third node hosting the resource; determining whether the realm identifiers are the same based on the comparing; and applying security policy to the request on the basis of whether the realm identifiers are the same. The received packet includes the realm identifier of the second node originating the request in an Internet Protocol (IP) portion of the header of the packet. The received packet can be in the form of a transmission control protocol/Internet protocol (TCP/IP) SYN packet for initiating a network connection. The method can further comprise the steps of extracting an index from the header of the received packet; retrieving a key corresponding to the index; and decrypting data identifying the user and data identifying the node originating the request using the retrieved key in the header of the packet. The applying of security policy can be performed on the basis of the data identifying the user and the node originating the request. The data identifying the first node and the data identifying the user of the first node can be included in the sequence number and acknowledgement number fields of a transmission control protocol (TCP) portion of the header of the packet without adverse impact on the TCP protocol. Also, the index can be included in the urgent pointer field of a transmission control protocol (TCP) portion of the packet header in a manner that does not adversely effect the TCP protocol. The decrypting step can further comprise decrypting an index in the header of the packet, and the method can further comprise the steps of comparing the decrypted index with the extracted index; determining whether the decrypted index and the extracted index are the same; if the decrypted index and extracted index are the same, transmitting the packet to the third node hosting the resource; and if the decrypted index and extracted index are not the same, dropping the packet having the request. These steps prevent the network connection from being hijacked as it is being established. The method can further comprise the step of, if the decrypted index and extracted index are not the same, logging the packet having the request. This can be used to provide a record of an attack which may have value in stopping an attack, preventing future attack, providing evidence of an attack for prosecution of the perpetrator, etc. The resource can include data for which access is requested, or a program to be launched in response to the request, or both. The packet can be received from a network such as the Internet. The method can further comprise determining whether the packet is permitted to be transmitted to the third node hosting the resource based on the application of the security policy; if the packet is permitted to be transmitted to the third node hosting the resource, transmitting the packet to the third node; and if the packet is not permitted to be transmitted to the third node hosting the resource, dropping the packet to prevent further communication with the first node originating the request. The method can further comprise, if the packet is not permitted to be transmitted to the third node hosting the resource, logging the request to access the resource.

A method according to a fourth embodiment of the invention comprises, at a first node, receiving a packet including a header with a realm identifier, and a request to access a resource; and providing access to the resource in response to the receiving step. The method can further comprise the steps of, at a second node, enforcing a security policy for a security realm including the first node; and if the enforced security policy permits, transmitting the packet to the first node. The second node can be in the same security realm as the first node. The second node can apply security policy on the basis of whether the first node and a third node originating the packet are in the same security realm as determined by the realm identifier included in the packet header. The second node can apply security policy on the basis of whether the first node and a third node originating the packet are in the same security realm as determined by the realm identifier included in the packet header.

An apparatus according to a fifth embodiment of the invention comprises a first node adapted to include a realm identifier identifying a security realm of the first node into a header of a packet requesting access to a resource. The first node can transmit the packet including the realm identifier from the first node to a second node hosting the resource via a network which can be the Internet. The first node can include the realm identifier in an Internet Protocol (IP) header of the packet, which can be a transmission control protocol/Internet protocol (TCP/IP) SYN packet for initiating a network connection. The first node can encrypt data identifying the first node and data identifying a user of the first node using a key; include the encrypted data in at least one field of the header of the packet; and include the index identifying the key in an additional field of the packet header. More specifically, the first node can include the encrypted data identifying the first node and the user of the first node in the sequence number and acknowledgement number fields of a transmission control protocol (TCP) portion of the header of the packet. The first node can include the index in the urgent pointer field of the TCP portion of the packet header. The first node can append the index to the data identifying the user of the first node before encrypting the data. The first node can generate the packet containing the request, or, it is possible that the packet could alternatively be generated by a different node and the realm identifier included in the packet by the first node after receiving it from such different node. The request can identify the resource as either one or both of data and a program hosted by a second node accessible by a destination address of the packet.

An apparatus according to a sixth embodiment of the invention is coupled to a network, and comprises a first node adapted to execute a realm module receiving a request to access a resource from an application running on the first node, retrieve a realm identifier of the first node, include the realm identifier in a header of a packet, and release the packet for transmission to a second node enforcing security policy for access to the resource. The first node can be a computer, and it can generate a request to designate a resource that includes either or both of data and a program. The packet can be a transmission control protocol/Internet protocol (TCP/IP) packet, or more specifically, a TCP/IP SYN packet. The apparatus can transmit the packet from the first node to the second node via the network, which can be the Internet.

An apparatus according to a seventh embodiment of the invention can be coupled to a network, and comprises a first node adapted to receive a packet having a header with a realm identifier of a second node originating the request, include a request to access a resource, retrieve a realm identifier of a third node hosting the resource, compare the realm identifier of the second node generating the request with the realm identifier of the third node hosting the resource, determine whether the realm identifiers are the same based on the comparing, and apply security policy to the request on the basis of whether the realm identifiers are the same. The first node can be adapted to receive the packet including the realm identifier of the second node originating the request in an Internet Protocol (IP) portion of the header of the packet. The received packet can comprise a transmission control protocol/Internet protocol (TCP/IP) SYN packet for initiating a network connection. The first node can extract an index from the header of the received packet, retrieve a key corresponding to the index, decrypt data identifying the user and data identifying the node originating the request using the key in the header of the packet, and apply the security policy on the basis of the data identifying the user and the data identifying the node originating the request. The first node can be adapted to receive the data identifying the first node and the data identifying the user of the first node from the sequence number and acknowledgement number fields of a transmission control protocol (TCP) portion of the header of the packet. Furthermore, the first node can be adapted to receive an index from the urgent pointer field of a transmission control protocol (TCP) portion of the packet header. The first node can be adapted to decrypt an index in the header of the packet, compare the decrypted index with the extracted index, determine whether the decrypted index and the extracted index are the same, and, if the decrypted index and extracted index are the same, transmit the packet to the third node hosting the resource, and, if the decrypted index and extracted index are not the same, drop the packet having the request. If the decrypted index and extracted index are not the same, the first node can log the packet including the request. The resource includes either one, or both, of data and a program. The first node can be adapted to receive the packet via a network, which can be the Internet. The first node can determine whether the packet is permitted to be transmitted to the third node hosting the resource based on the application of the security policy. If the packet is permitted to be transmitted to the third node hosting the resource, the method can further comprise transmitting the packet to the third node, and, if the packet is not permitted to be transmitted to the third node hosting the resource, the method can further comprise dropping the packet to prevent further communication with the first node originating the request. If the first node determines that the packet is not permitted to be transmitted to the third node hosting the resource, then the first node can log the request to access the resource.

An apparatus according to an eighth embodiment of the invention comprises a first node adapted to receive a packet including a header with a realm identifier and a request to access a resource, and to provide access to the resource in response to receiving the packet. The first node can be adapted to receive the packet from a second node enforcing a security policy for a security realm including the first node. The second node can be in the same security realm as the first node. The second node can apply security policy on the basis of whether the first node and a third node originating the packet are in the same security realm based on the realm identifier included in the packet header. The second node can apply security policy on the basis of whether the first node and a third node originating the packet are in the same security realm based on the realm identifier included in the packet header. The second node can apply security policy on the basis of whether the first node and a third node originating the packet are in the same security realm based on the realm identifier included in the packet header.

A system according to a ninth embodiment of the invention comprises first, second, and third nodes. The first node is adapted to include a realm identifier of the first node in a header of a packet requesting access to a resource, and is also adapted to transmit the packet including the realm identifier in the header of the packet via a first network. The second node is coupled to the first network to receive the packet including the realm identifier in the packet header from the first node, and is adapted to enforce a security policy in order to determine whether the packet is to be released to permit access to a resource based on the security policy. The third node is coupled to receive the packet via a second network if the packet is transmitted by the second node to the third node under the applied security policy. The third node is adapted to provide access to the resource based on the request included in the received packet. The second node can be adapted to compare the realm identifier of the first node from the packet header with a realm identifier of the third node hosting the resource. The second node can be adapted to determine whether the first and third nodes are in the same security realm based on the comparing. The second node can be adapted to apply security policy to the packet to control access by the first node to the resource hosted by the third node based on whether the first and third nodes are determined by the second node to be in the same security realm. The first network can be the Internet. The second network can be a local area network (LAN), or alternatively, it can be the Internet. The first node can include the realm identifier in an Internet Protocol (IP) header of the packet, which can be a transmission control protocol/Internet protocol (TCP/IP) SYN packet for initiating a network connection. The first node can be adapted to encrypt data identifying the first node and a user of the first node using a key; include the encrypted data in at least one field of the header of the packet; and include the index identifying the key in an additional field of the packet header. The first node can be adapted to include data identifying the first node and the user of the first node in the sequence number and acknowledgement number fields of a transmission control protocol (TCP) portion of the header of the packet. The first node can be adapted to include the index in the urgent pointer field of the TCP portion of the packet header. The first node can be adapted to append the index to the data identifying the user of the first node before encrypting the data. The first node can be adapted to generate the packet transmitted to the second node. The resource can include either one, or both, of data and a program.

A medium according to a tenth embodiment of the invention stores a computer program that when executed by a first node causes the first node to perform the step of including a realm identifier identifying a security realm of the first node into a header of a packet requesting access to a resource. The first node can further execute the computer program to perform the following additional step of transmitting the packet including the realm identifier from the first node to a second node hosting the resource via a network, which can be the Internet. The first node can further execute the computer program to include the realm identifier in an Internet protocol (IP) header of the packet, or more specifically, a transmission control protocol/Internet protocol (TCP/IP) SYN packet for initiating a network connection. The first node can execute the computer program to perform the additional steps of encrypting data identifying the first node and a user of the first node using a key; including the encrypted data in at least one field of the header of the packet; and including an index identifying the key in an additional field of the packet header. The first node can execute the computer program to include the data identifying the first node and the user of the first node in the sequence number and acknowledgement number fields of a transmission control protocol (TCP) portion of the header of the packet. The index can be included in the urgent pointer field of the TCP portion of the header of the packet. The first node can execute the computer program to perform the following additional function of appending the index to the data identifying the user of the first node before encrypting the data. The first node can execute the computer program to perform the additional function of generating the packet at the first node. The resource can include either one, or both, of data and a program.

A medium according to an eleventh embodiment of the invention stores a program that when executed by a first node causes the first node to perform the steps of receiving a request to access a resource from an application running on the first node; retrieving a realm identifier of the first node; including the realm identifier in a header of a packet; and releasing the packet for transmission to a second node enforcing security policy for access to the resource. The resource can comprise data or a program, or both. The first node can be implemented as a computer. The packet can be a transmission control protocol/Internet protocol (TCP/IP) packet, or more specifically, a TCP/IP SYN packet. The first node can execute the program to perform the step of transmitting the packet from the first node to the second node via a network, which can be the Internet.

A medium according to a twelfth embodiment of the invention stores a computer program that when executed by a first node causes the first node to perform the steps of receiving a packet having a header with a realm identifier of a second node originating the request, and including a request to access a resource; retrieving a realm identifier of a third node hosting the resource; comparing the realm identifier of the second node generating the request with the realm identifier of the third node hosting the resource; determining whether the realm identifiers are the same based on the comparing; and applying security policy to the request on the basis of whether the realm identifiers are the same. The received packet can include the realm identifier of the second node originating the request in an Internet Protocol (IP) portion of the header of the packet. The received packet can comprise a transmission control protocol/Internet protocol (TCP/IP) SYN packet for initiating a network connection. The first node can further execute the computer program to perform the steps of extracting an index from the header of the received packet; retrieving a key corresponding to the index; decrypting data identifying the user and data identifying the node originating the request using the key in the header of the packet. The applying of security policy can be performed on the basis of the data identifying the user and the node originating the request. The first node can execute the computer program to include data identifying the first node and the data identifying the user of the first node in the sequence number and acknowledgement number fields of a transmission control protocol (TCP) portion of the header of the packet. The index can be included in the urgent pointer field of a transmission control protocol (TCP) portion of the packet header. The first node can execute the computer program to decrypt an index in the header of the packet. The method can further comprise the steps of comparing the decrypted index with the extracted index; determining whether the decrypted index and the extracted index are the same; if the decrypted index and extracted index are the same, transmitting the packet to the third node hosting the resource; and if the decrypted index and extracted index are not the same, dropping the packet having the request. The first node can further execute the computer program to perform the step of, if the decrypted index and extracted index are not the same, logging the packet having the request. The resource can include either one, or both, of data and a program. The packet is received via a network, which can be the Internet. The first node can further execute the computer program to perform the additional steps of determining whether the packet is permitted to be transmitted to the third node hosting the resource based on the application of the security policy; if the packet is permitted to be transmitted to the third node hosting the resource, transmitting the packet to the third node; and if the packet is not permitted to be transmitted to the third node hosting the resource, dropping the packet to prevent further communication with the first node originating the request. The first node can further execute the computer program to perform the additional step of, if the packet is not permitted to be transmitted to the third node hosting the resource, logging the request to access the resource.

A medium according to a thirteenth embodiment of the invention stores a program that when executed by a first node causes the first node to perform the steps of receiving a packet including a header with a realm identifier, and a request to access a resource; and providing access to the resource in response to the receiving. The first node can execute the computer program to receive the packet from a second node enforcing a security policy for a security realm including the first node. The second node can be the same security realm as the first node. The second node can apply security policy on the basis of whether the first node and a third node originating the packet are in the same security realm based on the realm identifier included in the packet header.

### BRIEF DESCRIPTION OF THE SEVERAL VIEWS OF THE DRAWING

Having thus described the invention in general terms, reference will now be made to the accompanying drawings, which are not necessarily drawn to scale, and wherein:

FIG. 1 is a block diagram of an embodiment of the invention showing nodes of different security realms communicating with one another via a network such as the Internet;

FIG. 2 is a block diagram of an embodiment of the invention showing a network connection from a host computer of a first security realm, in which the host computer initiates communication through an enforcement computer with a resource computer of a second security realm via a network such as the Internet;

FIG. 3 is a block diagram of an Internet protocol (IP) packet structure indicating how a realm identifier can be included in the header of the IP packet to enable a receiving node to determine the security realm from which the packet originates, in accordance with an embodiment of the invention;

FIG. 4 is a block diagram of a transmission control protocol (TCP) packet incorporating a user identifier (UID 408), global key index (GKI 412), system identifier (SID 410), and session key identifier (SKI) in a TCP packet header, in accordance with an embodiment of the invention;

FIG. 5 is a flow diagram of a general method of an embodiment of the invention for including a realm identifier in a packet header;

FIG. 6 is a flow diagram of a method of an embodiment of the invention for applying security policy depending upon whether a packet initiating network communication contains a realm identifier in accordance with an embodiment of the invention;

FIG. 7 is a flow diagram of a method of an embodiment of the invention performed by a resource node to provide access to a requested resource;

FIG. 8 is a flow diagram of a relatively specific method of an embodiment of the invention for including a realm identifier in a packet header;

FIG. 9 is a flow diagram of a relatively specific method of an embodiment of the invention for applying security policy on the basis of whether a packet initiating communication contains a realm identifier;

FIG. 10 is a flow diagram of a relatively detailed method of an embodiment of the invention for applying security policy in the event that a realm identifier is not contained in the header of a packet initiating communication between network nodes;

FIG. 11 is a block diagram of a host computer of an embodiment of the invention that is adapted to include a realm identifier in a packet generated by such host computer to establish a network connection;

FIG. 12 is a block diagram of an embodiment of an enforcement computer for determining whether a packet initiating a communication with a resource computer protected by such enforcement computer is from the same security realm, and applying security policy based on such determination; and

FIG. 13 is a block diagram of a resource computer coupled to receive a request for access to a resource hosted by the resource computer that selectively provides access to the resource based on the enforcement computer's determination as to whether the connection is to be permitted.

### DETAILED DESCRIPTION OF THE INVENTION

The present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Definitions

‘And/or’ means ‘one, some, or all’ of the things immediately preceding and succeeding this phrase. Thus, ‘A, B and/or C’ means ‘any one, some or all of A, B and C.’

‘Computer’ can be any device capable of receiving input data, processing that data, and generating output data. The computer can be a personal computer, laptop computer, personal digital assistant (PDA), server, mainframe, minicomputer, or any other computing device. Examples are commercially available from numerous vendors, including Dell® Corporation, Round Rock, Tex.; Hewlett-Packard® Corporation, Palo Alto, Calif., IBM® Corporation, Armonk, N.Y., Sun Microsystems®, Inc., Sunnyvale, Calif., and numerous others.

‘Input Device’ can be a keyboard, keypad, mouse, joystick, trackball, pen, stylus or other device used to input data into a computer.

‘Memory’ or ‘computer-readable medium’ refers to virtually any element capable of storing data and/or code that can be read by a processor of a computer. “Memory’ includes within its meaning one or more transistors capable of storing data, a flip-flop, register, random-access memory (RAM) such as synchronous dynamic access RAM (SDRAM), read-only memory (ROM), flash memory, compact disc (CD), diskette, floppy disk, digital video disc (DVD), hard disk drive unit, disk storage unit, magnetic tape, etc. or any other device now existing or developed in the future that can be used to store data.

‘Network’ is a group of computers and associated devices (or nodes) connected to communicate with one another. The term can refer to a local area network (LAN), wide area network (WAN), metropolitan area network (MAN), Ethernet, Fast Ethernet, SONET, the Internet I and II, etc.

‘Operating system’ enables a processor to communicate with other elements of a computer. The operating system can be one of the systems sold under the marks Windows® CE, Palm OS, DOS, Windows® 95, Windows® 98, Windows® 2000, Windows® NT, Windows® XP, Solaris, OS/2, OS/360, OS/400, iSeries, eSeries, pSeries, zSeries, UNIX, LINUX, AIX, and numerous others.

‘Output Device’ refers to a device such as a monitor, cathode ray tube (CRT), liquid crystal display (LCD), or other device, for generating a display of a computer.

‘Processor’ can be virtually any element capable of processing data, including a microprocessor, microcontroller, programmable gate array, field programmable gate array (FPGA), programmable logic array (PLA), programmable array logic (PAL), etc. The processor can be configured to process data represented in electromagnetic-form, including electrical, optical, electro-optical, or magnetic data, for example.

‘(s)’ or ‘(ies)’ means one or more of the thing meant by the word immediately preceding the phrase ‘(s)’ or ‘(ies).’ Thus, “computer(s)” means “one or more computers.”

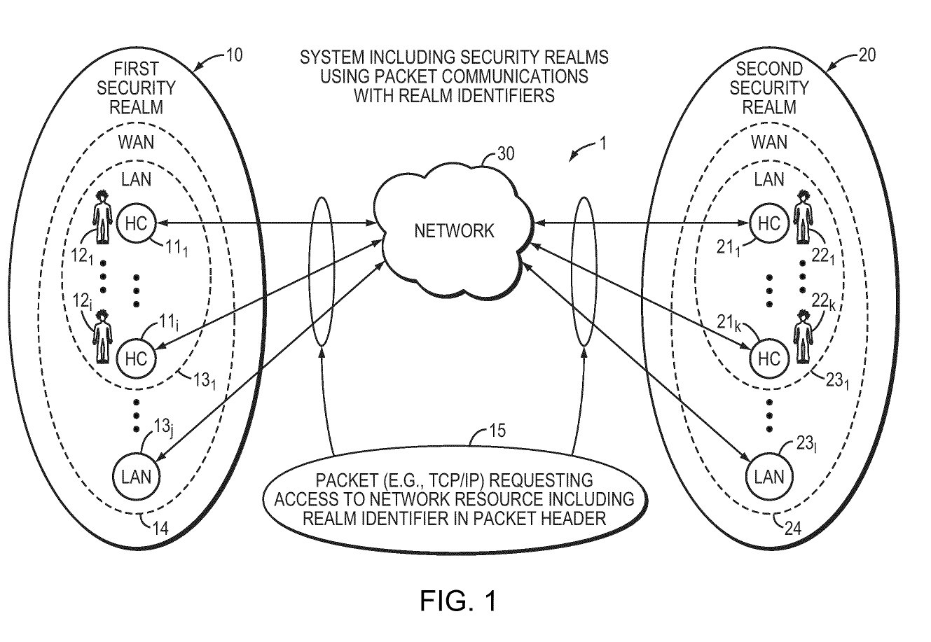

FIG. 1 shows an embodiment of a system 1 comprising first security realm 10 and second security realm 20 coupled in communication with one another via network 30. The network 30 can be the Internet, for example. The first security realm 10 comprises one or more host computers 11₁-11ᵢ (wherein i is a positive integer) and respective users 12₁-12ᵢ. The host computer(s) 11₁-11ᵢ can be included within a local area network (LAN) 13₁, which can constitute part of a wide area network (WAN) 14 within the first security realm. Those of ordinary skill in the art will appreciate the fact that the specific architecture of a security realm is not generally limited. For example, a security realm can include one or more users 12₁-12ᵢ and computers 11₁-11ᵢ, within a single LAN 13₁ or distributed in multiple LANs 13₁-13ⱼ (wherein j is a positive integer). One or more user computers and LANs can be interconnected to permit communication via one or more WANs. What is important to understand for purposes of this disclosure is that a security realm comprises one or more users and network nodes (e.g., host computers) that belong to an entity to which security policy is to be applied differently as compared to users and nodes outside of the entity. Thus, if the entity is a company, then all users that are employees of the company and the computers they use are considered to belong to the same security realm to which a common security policy applies. The network security policy is different, and generally more restrictive in terms of the privileges a user or node of a foreign realm has as compared to member users or nodes of the security realm applying its policy. Although a security realm is commonly defined on the level of member users and nodes of a single company, there is generally no restriction to how one might define a security realm in terms of the member users and nodes encompassed within it. Thus, for example, a security realm can be defined more generally than the organization level to include users and nodes of groups of organizations, or more narrowly to include groups, departments, divisions, etc. within an organization.

Similarly to the first security realm 10, the second security realm 20 can comprise one or more host computers 21₁-21ₖ (wherein k is a positive integer) and respective users 22₁-22ₖ. The LAN 13₁ can be included within a LAN 23₁ or larger WAN 24. In addition, as with the first security realm, the second security realm can include one or more users 22₁-22ₖ and computers 21₁-21ₖ, within a single LAN 23₁ or distributed in multiple LANs 23₁-23ₗ (wherein 1 is a positive integer). The host computers 11, 21 are coupled to the network 30 and thus can communicate with one another via such network 30.

When the host computer 11 requests access to a resource (e.g., application, data, service, etc.) hosted by the computer 21, it includes its realm identifier in a packet 15 requesting access to the resource and transmits same over the network 30 to the host computer 21. The host computer 21 receives the transmitted packet 15, and examines its realm identifier, in this case determining that the packet originates from host computer 11 which is not in the same security realm as the host computer 21. Thus, the host computer 21 (or another node charged with enforcement of the security policy) applies its security policy pertaining to communications with foreign security realms in order to determine whether the communication is permitted. If so, the host computer 21 (or other enforcement node) permits access to the resource it hosts. Conversely, if the connection is not permitted, then the host computer 21 (or other node enforcing the security policy) logs the request and drops the packet. Because in this case the host computer 21 returns no packet, the host computer 11 has no opportunity to receive information regarding the host computer 21 which it could possibly use to attack the host computer 21.

Similar process flow applies to communications originating form the host computer 21 and received by the host computer 11 via the network 30. Specifically, if requesting access to a resource hosted by the host computer 11, the host computer 21 includes a realm identifier for the second security realm 20 in the header of a packet 15 incorporating its request to access the resource (e.g. a TCP/IP SYN packet). It transmits this packet to the host computer 11 via the network 30. The host computer 11 receives and examines the realm identifier in the received packet 15, and determines in this case that the received packet is not from another node within its own security realm 10, but is instead from a node of a foreign realm. The host computer 11 (or an enforcement node) thus applies its security policy for foreign realms to determine how the request for resource access is to be processed. If access to the resource is permitted, then the host computer 11 provides access to the requested resource. Conversely, if the host computer 11 determines that connection to the requesting computer 21 in the foreign realm 20 is not permitted, it logs the request and drops the packet, exposing no information to the host computer 21 that could be exploited in an attack.

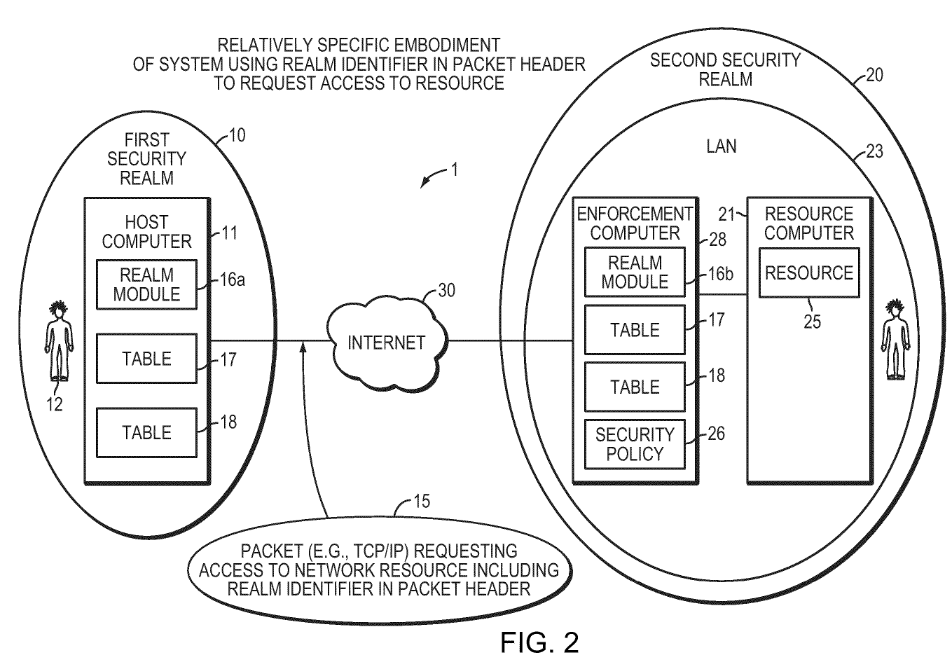

FIG. 2 is a relatively specific embodiment of FIG. 1 for a typical implementation of the system 1. In FIG. 2 the host computer 11 of security realm 10 comprises a realm module 16a. This software is executed by the host computer 11, which causes same to include the realm identifier for the security realm 10 into the header of a packet 15 requesting access to a network resource in this exemplary embodiment hosted by the second security realm 20. The realm module 16a is in this case executing on host computer 11 in ‘request’ mode.

The second security realm 20 comprises a LAN 23 which in this embodiment has an enforcement computer 28, which serves as a gateway for the LAN 23 to the network 30, and a resource computer 21. The enforcement computer 28 executes the realm module 16b which in this exemplary embodiment operates in ‘enforcement’ mode to enforce the security policy of the second security realm 20 against requests to access the resource 25 hosted by the resource computer 21. In this exemplary embodiment, the enforcement computer 28 receives the packet requesting access to the resource 25 from the host computer 11. The enforcement computer 28 executes the realm module 16b to determine that the realm identifier within the received packet 15 originates from a different security realm. The enforcement computer 28 refers to its security policy to determine if access to the resource 25 is permitted to the host computer 11 in the first security realm 10. If so, then the enforcement computer 28 releases the packet to the resource computer 21 which provides the resource 25 to the host computer 11 of the security realm 10 via the network 30. Conversely, if the enforcement computer 28 determines that access to the resource 25 is not permitted to the host computer 11 under the security policy of the second security realm 20, then the enforcement computer 28 logs the request and drops the packet requesting access to the resource 25, preventing the host computer 11 from receiving any information it could use to attack the second security realm 20.

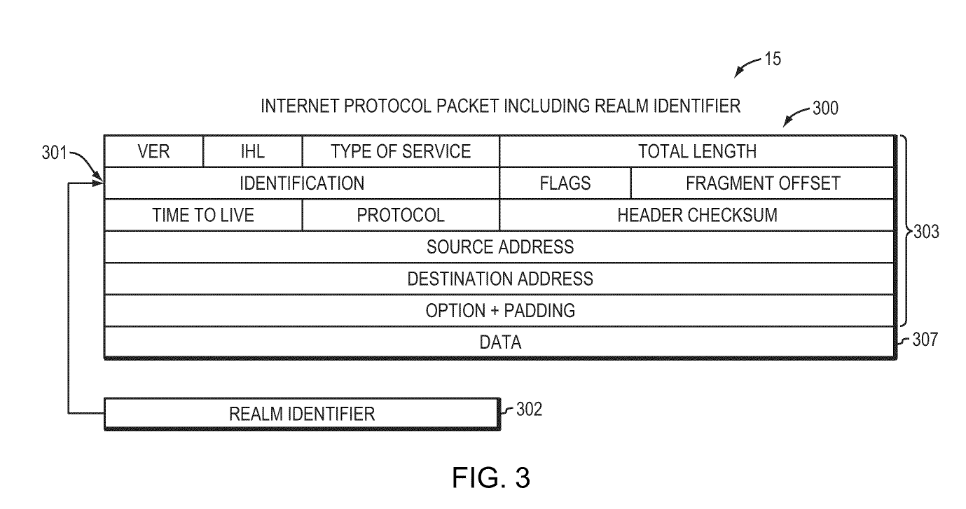

FIG. 3 shows the basic structure of an Internet protocol (IP) packet 15 as modified for use in embodiments of the invention. This packet structure is well-known to those of ordinary skill in the art, and is defined under IETF RFC 791. The packet 15 comprises various fields, including version (VER), Internet header length (IHL), type of service, total length of packet (total length), identification, flags, fragment offset, time to live, protocol, header checksum, source address, destination address, options and padding, and data 307. The field of interest to this disclosure is the identification field 301 in which the realm identifier 302 is inserted. Thus, the node or computer requesting access to a resource includes its realm identifier 302 in the identification field 301 of header 303 of IP packet 15, enabling the receiving node to enforce its security policy using the realm identifier 302. Although the identification field is usable as a field in which to include the realm identifier, alternatively, those of ordinary skill in the art will appreciate that the realm identifier can be included in a different field of a packet header so long as the receiving and sending computers are programmed to check such field. Of course, the field selected for inclusion of the realm identifier should be one that does not adversely impact use of the protocol to communicate.

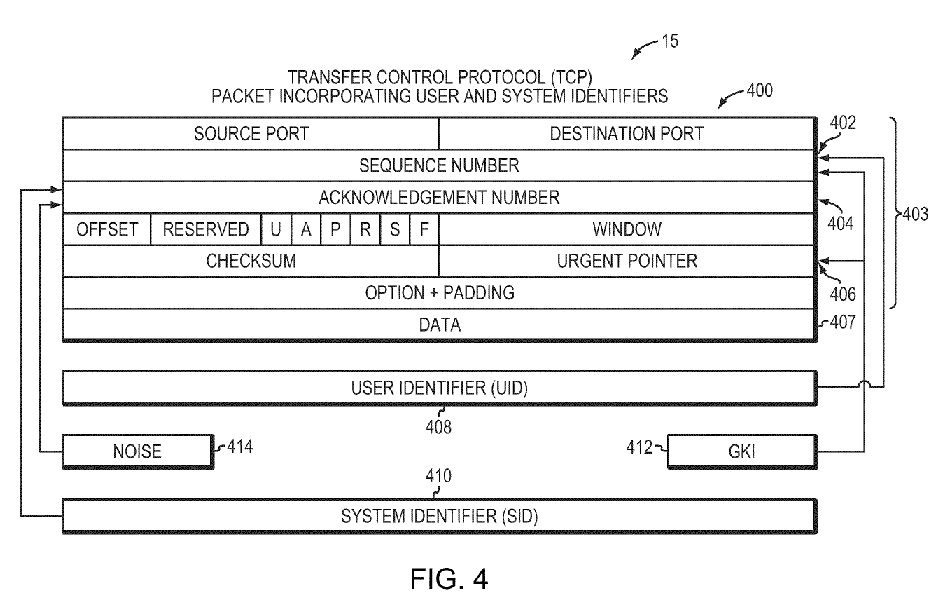

FIG. 4 shows the basic fields in a transmission control protocol (TCP) packet modified in accordance with embodiments of the invention to incorporate a user identifier (UID 408), system identifier (SID 410), and general key index (GKI 412), into certain fields of the packet header. The TCP packet structure includes a header with source port, destination port, sequence number 402, acknowledgement number 404, offset, reserved, U, A, P, R, S, and F fields, window, checksum, urgent pointer 406, option and padding fields, and the data field 407. The UID 408 and SID 410 identify the user and system (i.e. computer or node) initiating network communication. The GKI 412 is a key index that points to a key value stored in a global key table accessible to the realm module 16a, 16b at respective nodes 11, 21.

The transmitting node encrypts the UID 408, SID 410, and GKI 412, and inserts the encrypted data into the fields of the packet header. More specifically, the transmitting host computer node 11 retrieves the user name and domain name and uses same to compute the UID 408. This can be done by concatenating and hashing the user name and domain name to generate a 24-bit number. The host computer 11 randomly selects a GKI 412 from the global key table, and concatenates the same to the UID 408 to produce a 32-bit number. The host computer 11 retrieves the SID 410 from its memory. A host computer 11 computes its SID 410 when its realm module 16 is booted-up. For example, the SID 410 can be derived by the host computer 11 by retrieving the MAC address of the network interface card (NIC) of such host computer 11, and concatenating same with a timestamp corresponding to the time at which the realm module 16a was added to the host computer 11. The resulting value can be hashed to produce a 24-bit SID 410 value. The host computer 11 concatenates eight (8) bits of noise 414 (i.e., a randomly generated number) to the 24-bit SID 410 value to produce a 32-bit number.

The 32-bit value including the UID 408 and GKI 412, and the 32-bit value including the SID 410, SKI, and noise 414, are concatenated together, and the two concatenated words are subjected to DES encryption using the global key indicated by the selected GKI 412. Such DES encryption is well known to persons of ordinary skill in the art. The host computer 11 inserts the encrypted UID 408 and GKI 412 into the sequence number field of the TCP packet, and the SID 410 and noise 414 are inserted into the acknowledgement number field of the TCP packet. The IP packet with realm identifier is combined with the TCP packet to form a TCP/IP packet. The host computer 11 releases the thus-formed TCP/IP packet to the TCP/IP stack for transmission to the receiving node, in this exemplary embodiment, the resource computer 21, via the network 30.

The enforcement computer 28 receives the transmitted TCP packet via the network 30. It executes the realm module 16b in the ‘enforcement’ mode to receive the TCP/IP packet, and examines the realm identifier contained therein to determine whether it originates from the same realm as that of the enforcement computer 28 and the resource computer 21. In this case, the enforcement computer 28 uses the realm identifier to determine that the TCP/IP packet originates from a different realm. Thus, the enforcement computer 28 applies its security policy 26 on the basis that the packet originates from a node that is not within the security realm 20 to which the enforcement computer 28 and resource computer 21 belong. The enforcement computer 28 either permits the communication or drops the TCP/IP packet and logs the request, according to the security policy 26.

To ensure that the TCP/IP communication has not been hijacked by an attacker, the enforcement computer 28 extracts the GKI 412 from the urgent pointer field 406, and obtains the corresponding general key from its key table 17. The enforcement computer uses this global key to decrypt the sequence number and acknowledgement number fields using reverse DES, and extracts the GKI 412 from the sequence number field, to ensure it is the same as the GKI 412 from the urgent pointer field 406. This helps to ensure that the connection has not been hijacked by an attacker. If the enforcement computer 28 determines that the GKI 412 from the urgent pointer field 406 and the GKI 412 decrypted from the sequence number field 402 are not the same, then the enforcement computer 28 logs the connection request and drops the connection. Conversely, if the GKI 412 from the urgent pointer field 406 and the GKI 412 decrypted from the sequence number field 402 are the same, then the computer 28 proceeds by applying its security policy 26 to determine whether the packet 15 should be released to the resource computer 21 to permit the user 12 of host computer 11 to access the resource 25. If the security policy 26 does not permit the user 12 to access the resource 25, then the enforcement computer 28 logs the access request and drops the network connection. Conversely, if the enforcement computer 28 determines that its security policy 26 permits the network connection, then the enforcement computer releases the packet 15 to the resource computer 21 to permit a network connection to be established which enables the user 12 of the host computer 11 to access the resource 25 hosted by the resource computer 21.

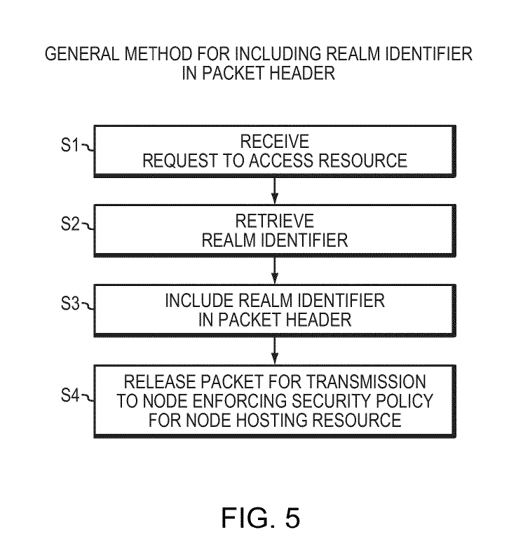

FIG. 5 is a general method of an embodiment of the invention for including a realm identifier in a packet header. This method can be conducted by a host computer executing a realm module. In Step S1 of FIG. 5 a request to access a resource is received. The request can be received by the realm module from an application executed by the host computer. The request can be generated by a user of the application executed by the host computer, for example, resulting in generation of a request which is “pushed” down from the application layer to the physical layer of the network communication architecture used by the network 30 (see, e.g., the ISO/OSI reference model). The “pushed’ request is thus transmitted to a remote node enforcing security policy for the realm hosting the requested resource, where the various headers of the packet are successively processed to extract the request ultimately at the application level. In Step S2 the host computer retrieves its realm identifier in order to include same in the packet requesting access to the resource. In Step S3 the realm identifier is included in the packet header for transmission to the node enforcing security policy for the node hosting the resource (which may be the same or different nodes). In Step S4 the host computer releases the packet for transmission to the computer enforcing the security policy for the realm hosting the resource (e.g., such as enforcement computer 28 in FIG. 2). This concludes the method for including a realm identifier in a packet header.

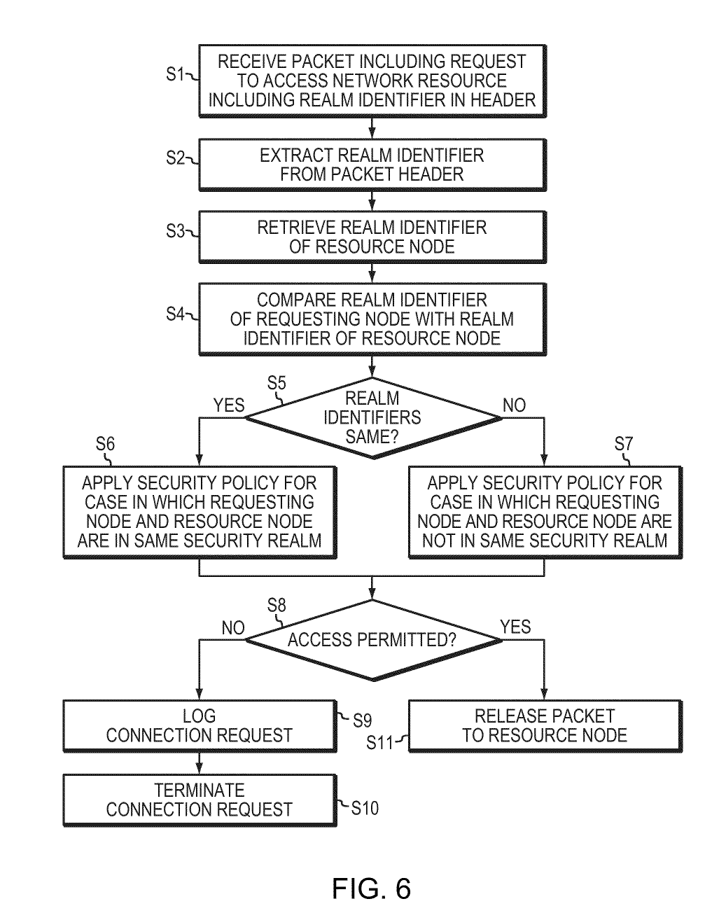

FIG. 6 is a flow diagram of a method in accordance with an embodiment of the invention performed by an enforcement node which enforces security policy for the realm hosting a resource requested by a host computer. The enforcement node is normally the enforcement computer 28 of FIG. 2. Alternatively, the enforcement node can be the resource computer 21 in which case both the realm module 16 and the resource 25 are hosted by the same computer. As yet another alternative, the enforcement node can be an entirely different computer coupled to communicate with the host computer 11 and the resource computer 21 via the network 30.

In Step S1 of FIG. 6 the enforcement node receives the packet having a request to access a network resource and including a realm identifier in its header. In Step S2 the enforcement node extracts the realm identifier from the packet header. In Step S3 the enforcement node retrieves the realm identifier of the resource node. In Step S4 the enforcement node compares the realm identifier of the requesting node with the realm identifier of the resource node. In Step S5 the enforcement node determines whether the realm identifier of the request packet is the same as the realm identifier of the resource node hosting the resource. If so, in step S6 of FIG. 6, the enforcement node applies the security policy for the case in which the requesting node and resource node are in the same security realm. Conversely, if the realm identifiers are not the same in Step S5, the enforcement node applies the security policy for the case in which the requesting node and the resource node are not in the same security realm. After performance of Step S6 or S7, a determination is made in step S8 to establish whether the request for the resource is to be permitted. If not, then the enforcement node logs the connection request in Step S9. In Step S10, the enforcement node terminates the connection request. Conversely, if in Step S8 the enforcement node determines that access to the resource is permitted, then it releases the packet to the node hosting the resource in Step S11.

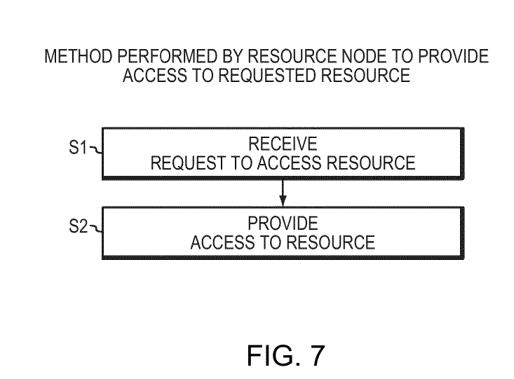

FIG. 7 is a flow diagram of steps performed by a resource node (e.g., resource computer 21 of FIG. 2) to process a request to access a resource. In Step S1 the resource computer 21 receives the request to access the resource. This request has been previously screened by the enforcement node using the security policy to ensure that it is permissible. Alternatively, if the enforcement node and resource node are the same node, the realm module has been previously executed in order to apply the security policy to the request. In either case, the resource node responds in Step S2 by providing access to the resource. What this action entails depends upon the nature of the resource requested. If the request is directed to a particular application, then the resource computer launches same. If the resource is data, then the resource computer causes an appropriate query to be generated to retrieve the requested data, and transmits same to the requesting node via the network 30. If the resource is a service such as email, file transfer protocol, etc., then the resource computer provides access to such service to the requesting node. Those of ordinary skill in the art understand that the resource can be many things, and thus it is intended herein to cover all such possibilities as being the target of a request in different embodiments of the invention.

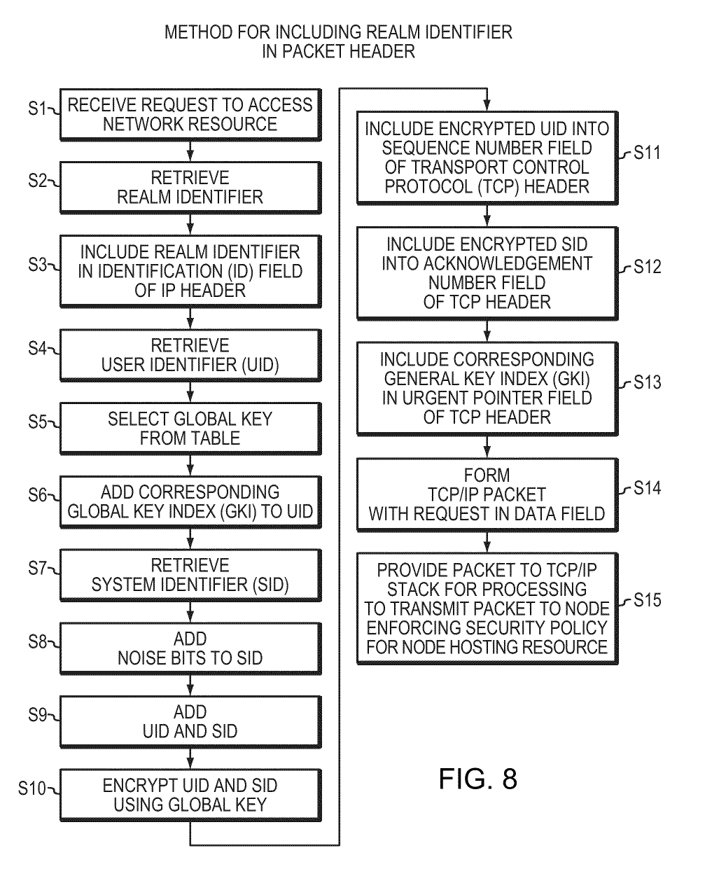

FIG. 8 is a relatively detailed flow diagram of a method in accordance with an embodiment of the invention for inserting a realm identifier into the header of a packet. These steps can be performed by the host computer 11 to generate a packet with a header including a realm identifier to reveal to the receiving node the security realm from which the packet originates. The method of FIG. 8 begins in Step S1 in which a request to access a network resource is received. This request can be received by the realm module 16 via an application (e.g., a web or http application) generating the request. In Step S2 of FIG. 8, the realm module 16 retrieves the realm identifier 302 identifying the realm from which the request originates. Ordinarily, this realm includes both the computer 11 and the user 12 originating the request. The realm identifier 302 and realm module 16 are normally installed together into the computer 11 to enable it to include the realm identifier in packet communications. In Step S3 the realm identifier is included in the header of an IP packet. The realm identifier can be included in the identification (ID) field of the IP packet header. In Step S4 the user identifier (UID 408) is retrieved. The host computer 11 can compute the UID 408 using the user name and domain name corresponding to the domain of which the computer 11 is a member, and retrieve the resulting value from its memory. In Step S5 a global key is selected. The computer 11 can be programmed to perform Step S5 by random selection of a global key from the global key table. In Step S6 the global key index (GKI 412) corresponding to the selected global key is added to the UID 408. The computer 11 can perform this step by concatenating the GKI 412 to the UID 408. In Step S7 the system identifier (SID 410) is retrieved. This step can be performed by the computer 11 by retrieving the SID 410 from its memory. In Step S8 noise 414 bits are added to the SID 410. This is done in order to preserve randomness of the sequence number field in accordance with preferred TCP protocol. The computer 11 can generate such noise 414 by generating a random number, and concatenating the same to the SID 410. In Step S9 the UID 408 and SID 410 are added or concatenated together. In Step S10, the combined UID 408 and SID 410 are encrypted using the selected global key from Step S5. The first word of the resulting value including the encrypted UID 408 and GKI 412, are included in the sequence number field of the TCP packet header in Step S11 of FIG. 8. In Step S12 of FIG. 8, the second word of the resulting value, which includes the encrypted SID 410 and noise 414 bits, is included into the acknowledgement field of the TCP packet header. In Step S13 the GKI 412 is included into the urgent pointer field of the TCP packet header. In Step S14 TCP/IP packet is formed by combining the TCP and IP packet headers and including the request to access the resource in the data field of the resulting packet. In Step S15 the packet is provided to the TCP/IP stack for processing to transmit the packet to the node enforcing security policy for the realm hosting the resource to which access is requested.

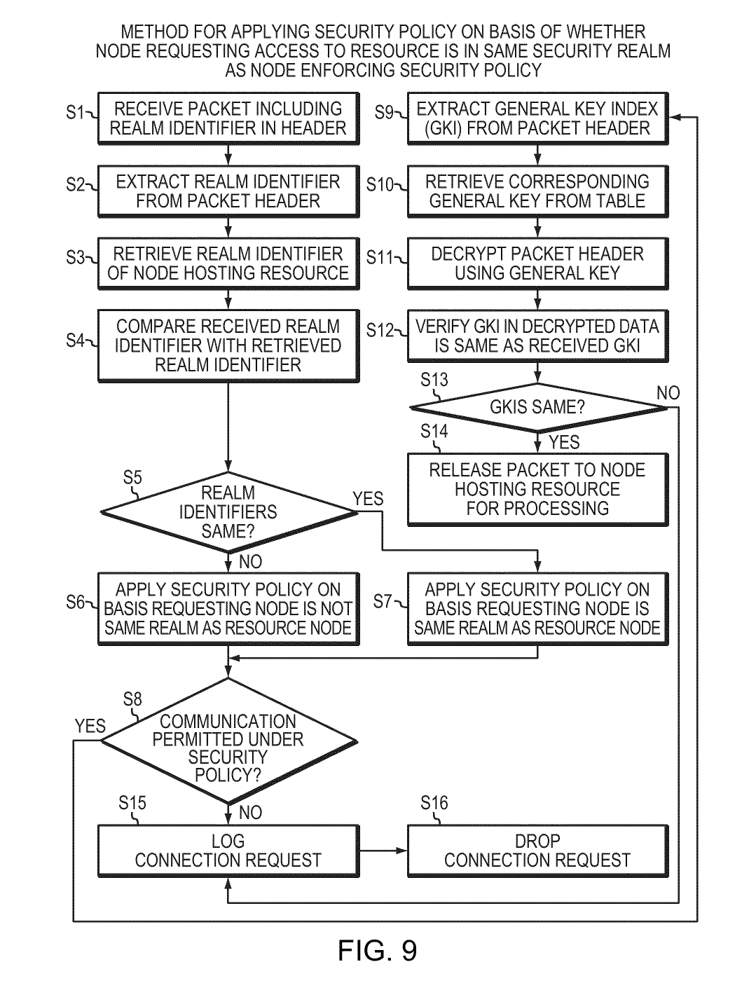

FIG. 9 is a method of an embodiment of the invention for applying security policy on the basis of whether or not the node requesting access to a resource is in the same security realm as the node hosting the resource. This method can be performed by enforcement computer 28, or other node programmed to enforce security policy on the basis of the realm of the node requesting access to a resource as compared to the realm of the node hosting a resource. In Step S1 of FIG. 9 a packet including the realm identifier for the node requesting access to a resource, is received. The packet including the realm identifier can be received from the requesting node 11 via the network 30. In Step S2 the realm identifier is extracted from the packet. In Step S3 the realm identifier of the node hosting the resource is retrieved. In Step S4 the received realm identifier is compared with the retrieved realm identifier to determine whether they are the same. In Step S5 a determination is made to establish whether the realm identifier of the node 11 requesting access to the resource 25 is the same as the node 21 hosting the resource. If the realm identifiers are not the same, then in Step S6, the network security policy is applied on the basis that the realm of the node originating the request to access the resource is not the same as the realm of the node hosting the resource. Conversely, if the realm identifiers are the same, then in Step S7 the security policy is applied on the basis that the requesting node is in the same realm as the node hosting the resource. The security policy will generally be more restrictive in the case in which the security policy originates from a realm outside of that hosting the resource, as compared to the situation in which the node generating the request for resource access is within the same realm as the node hosting the resource. In Step S8, on the basis of the security policy applied in either Step S6 or S7, a determination is made to establish whether the connection to the resource node is to be permitted to the requesting node. If affirmative, then processing proceeds to Steps S9-S13 in which a check is made to ensure that the connection has not been hijacked. In particular, in Step S9 the enforcement node extracts the global key index (GKI 412) from the header of the received packet, retrieves the corresponding global key from the global key table in Step S10, and uses such key to decrypt the packet header in Step S11. In Step S12 the enforcement node verifies whether the GKI 412 from the sequence number field of the decrypted packet header, is the same as the decrypted GKI 412 in the urgent pointer field. In Step S13 a determination is made to establish whether the GKI 412 decrypted from the urgent pointer field and the GKI 412 decrypted from the sequence number field, are the same index. If so, in Step S14, it is relatively assured that network connection in the process of being established has not been hijacked, and the packet is released to the resource node 21 to establish a network connection with the requesting node 11. Conversely, if the GKI 412s are determined not to be the same in Step S13, or if the performance of Step S8 results in a negative determination, then the method proceeds to Step S15 in which the connection request is logged to provide a record of the attempt to access the resource. This can be used for taking security measures against the originating node (e.g., prohibiting network access to subsequent requests originating from the same node, forensics in investigation of an attack or incident, prosecution of an attacker, etc.) In Step S16 the connection request from the originating node is dropped. The enforcement node thus prevents the requesting node from establishing a network connection that could be exploited by an attacker to obtain unauthorized access to a resource. The enforcement node further prevents the unveiling of information regarding the security realm receiving the request.

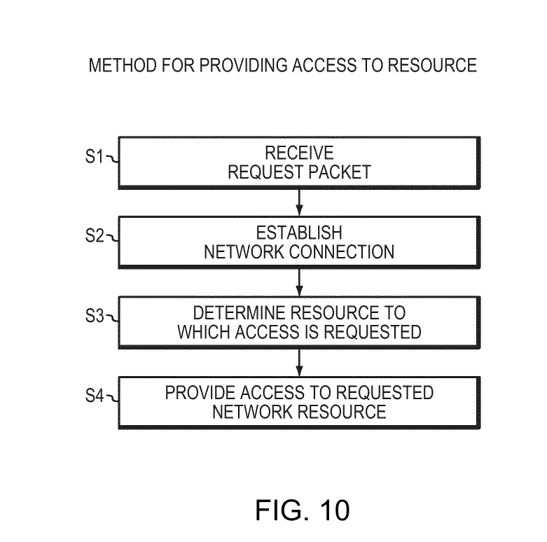

FIG. 10 is a method of an embodiment of the invention for providing access to a resource. The method can be performed by the resource node 21 in response to receiving a packet requesting access to a resource 25 hosted by the resource node 21, which packet has been released by the enforcement node 28 after determining that the request to access the resource is permitted under the security policy applied by the enforcement node. In Step S1 the resource node 21 receives the packet requesting access to a resource. In Step S2 the resource node 21 establishes a network connection with the request node 11. The enforcement node 28 can intermediate this connection so that all communication from request node 11 to resource node 21, or vice versa, flows through the enforcement node 28 to provide the ability to control the connection from the enforcement node if desired. In Step S3 the resource node 21 analyzes the request packet to determine what resource is to be accessed. The resource could be a particular program or data, for example. In Step S4 the resource node 21 provides access to the requested network resource. The resource node 21 can provide such access via the network 30, optionally through intermediation by the enforcement node 28.

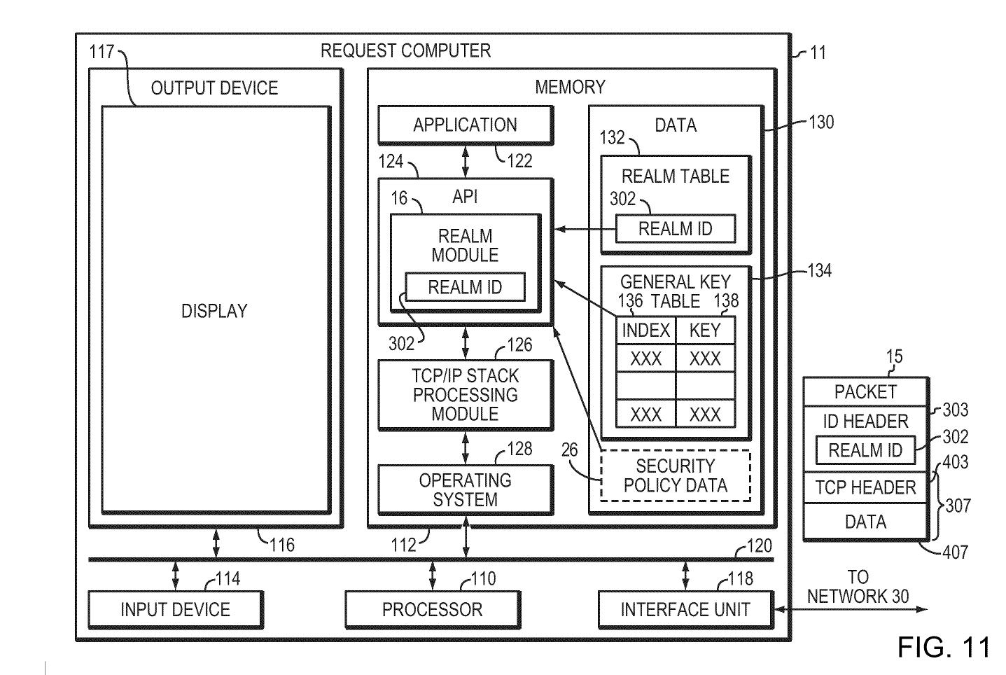

FIG. 11 is an embodiment of the request computer 11 that generates a request to access a resource. The request computer 11 basically comprises a processor 110, a memory 112, an input device 114, an output device 116, an interface unit 118, and a bus 120 coupling these elements together. The memory 112 includes an application 122, an application program interface (API) 124 including realm module 16, a TCP/IP stack processing module 126, an operating system 128, and data 130. The data 130 comprises a realm table 132 including a realm identifier 302 and a general key table 134 comprising a listing of indexes (GKI 412s) 136 and corresponding general keys 138. Security policy data 26 can be included in the data 130 to enable the request computer 11 to enforce its own security policy in the event that it receives requests from other nodes. However, such security policy data 26 is not essential in the situation in which the request computer 11 is merely generating a request to access a resource, and not protecting a resource under a security policy. It should thus be understood that the realm module 16 can be such as to enable any node to adopt one or more roles, including functioning to request access to a resource, enforce a security policy, and provide access to a resource.

The processor 110 executes the application 122. This can be done in response to a user 22 operating the input device 114 to request launch of the application 122. The launch of the application 122 triggers the processor 110 to load and execute the API 124 which includes the realm module 16. The user 22 operates the computer 11 using the input device 114 and the output device 116 providing a user interface, to cause the application 122 to generate a request to access a resource 25 hosted by a resource computer 21. In response to the request, the API 124, or more specifically, the realm module 16, generates a packet and includes its realm identifier 302 in the header of such packet. The packet can be a SYN packet which is the first packet of a SYN-ACK-SYNACK packet exchange required to establish a network connection in TCP/IP protocol. The realm module 16 releases the packet to the TCP/IP stack processing module 126, which in turn transmits the packet to the operating system 128. The processor 110 executes its operating system 128 to transmit the packet to the interface unit 118 (such as a network interface card (NIC)) via the bus 120. The interface unit 118 transmits the packet to the enforcement node 28 via the network 30 which has nodes to route the packet according to its destination address.

If the enforcement node 28 and resource node 21 do not permit access to the resource 25 based on the security realm 10 of the request computer 11, such nodes transmit nothing back to the computer 11 so that it receives no information that can be exploited in an attack. Conversely, if the security policy enforced by the node 28 permits access to the resource, then the node 28 responds to the SYN packet with an ACK packet standard in TCP/IP protocol. The request node 11 responds to the ACK packet with a SYNACK packet to complete the three-way handshake needed to establish a TCP/IP connection. The enforcement node 28 also establishes communication with the resource node 21 to permit the user 22 of the request node 11 to access the resource 25 hosted by such node. The user 22 can access the resource 25 by using the user interface provided by the input device 114 and output device 116 generating display 117 in conjunction with the processor 110. Alternatively, the application 122 can be such that the packet requesting access to the resource is generated automatically by the processor 110 without requiring any action on the part of a human user 22.

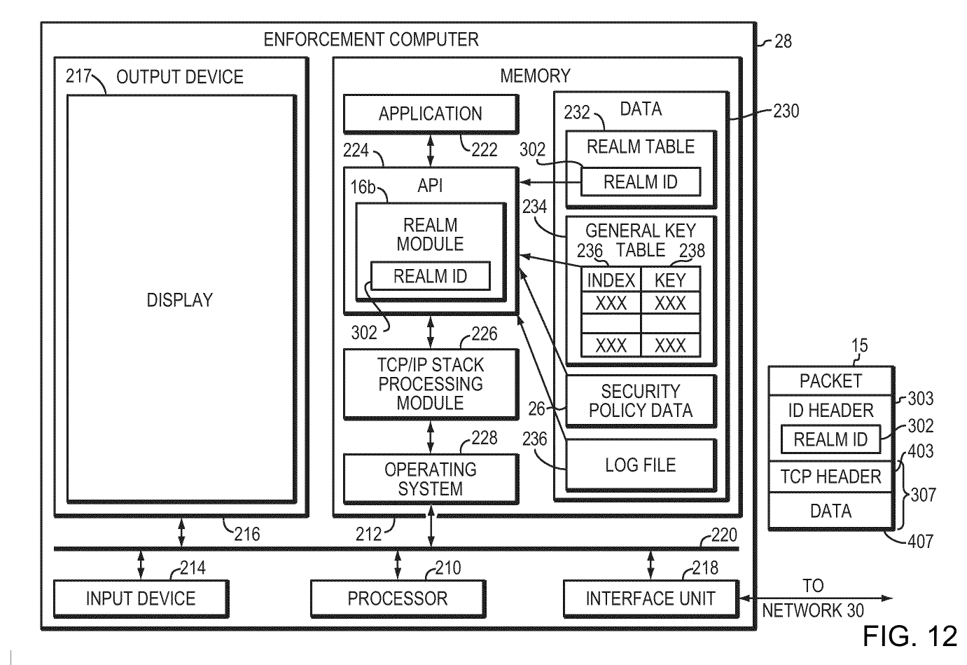

FIG. 12 is a block diagram of an embodiment of the enforcement computer 28 in accordance with the invention. The enforcement computer 28 comprises a processor 210, a memory 212, an input device 214, an output device 216 generating display 217, and an interface unit 218, coupled via bus 220. The memory 212 stores an application 222, an API 224, a TCP/IP stack processing module 226, an operating system 228, and data 230. The memory 212 stores an API 224 including the realm module 16b which enforces the security policy based on whether the request to access the resource originates from inside or outside of the security realm of the resource for which the enforcement computer 28 is enforcing security policy. The TCP/IP stack processing module 226 performs the processing of packets required in TCP/IP protocol to receive and send packets. The operating system 228 is executed by the processor 210 to permit it to communicate with other elements of the enforcement computer 28 via the bus 220. The data 230 includes a realm identifier (ID) 302, a realm table 232, a general key table 234, security policy data 26, and log file 236. The realm identifier 302 in the memory 230 permits the processor 210 to verify that the API 224 is running on the same computer in which it was originally installed. The processor 210 does this by comparing the realm identifier 302 from its memory 230 and the realm identifier 302 from the realm module 16b, and verifying that the two are the same. If not, then further execution of the API 224 causes the processor 210 of the computer 28 to prevent further execution of the application 222 or the API 224. Conversely, if the realm identifiers 302 match, then the processor 210 permits execution of the application 222 and the API 224.

In operation, the enforcement computer 28 receives a request to access a resource 25 from a request computer 11 via the network 30. The interface unit 218 receives the request (e.g., SYN) packet and causes the processor 210 to execute the operating system 228 and TCP/IP stack processing module 226 to receive the packet and store same in a receive buffer of the module. The processor 210 further executes the API 224 including realm module 16b and the application 222 in order to enforce the security policy defined by the data 26. This causes the enforcement computer 28 to extract the realm identifier 302 included in the header 303 of the packet 15 transmitted from the request computer 11 via the network 30. The processor 210 compares the realm identifier 302 from the packet 15 with its own realm identifier 302 to determine whether the request originates from within or outside of the security realm 20 hosting the requested resource. If the enforcement computer 28 is in the same realm as the requesting computer 11, then the enforcement computer 214 applies its security policy as indicated by the data 26 on this basis. Conversely, if the processor 210 determines that the resource request originates from a different security realm, then it applies the security policy indicated by the data 26 on this basis. Generally, the security policy is normally more restrictive in the case in which the security realms are different as opposed to the case in which they are the same realm. Regardless of whether the request to access a resource originates from a node inside or outside of the security realm hosting the resource, the processor 210 can further apply security policy on the basis of either or both of the UID 408 identifying the user originating the request and the SID 410 identifying the node 11 originating the request. If access to the resource is permitted under the security policy defined by the data 26, then the realm module 16b is executed by the processor 210 to extract the GKI 412 from the urgent pointer field of the packet, and retrieve the corresponding key from the general key table 234. The processor 210 further executes the application 222 and realm module 16b of the API 224 to decrypt data in the packet header to determine if the last bits of the sequence number match the GKI 412. If the computer 28 determines that the realm identifier does not match the last bits of the sequence number field, then the computer 28 stops further processing to establish a TCP/IP connection because it is likely that the TCP/IP connection has been hijacked. Conversely, if the extracted GKI 412 and last bits of the sequence number match, then it is relatively unlikely that the connection has been hijacked. The processor 210 then executes the application 222 and the API 224 on the basis that the connection has not been hijacked by transmitting an ACK packet to the requesting computer 11 via the bus 220, interface unit 218, and network 30. In response to the ACK packet, the computer 28 receives a SYNACK packet from the request computer 11 and establishes a network connection with the computer 11 via the network 30 in accordance with usual TCP/IP communication. The processor 210 also executes the application 222, API 224, TCP/IP stack processing module 226, and operating system 228 to release the SYN packet containing the request to the resource computer 21. The released SYN packet causes the resource computer 21 to establish a connection with the enforcement computer 28 to permit the computer 11 to access the resource hosted by the computer 21. Conversely, if the processor 210 determines that the security policy indicated by data 26 does not permit access to the resource, or if the GKI 412 from the urgent pointer field of the packet does not match the decrypted bits from the sequence number field of the received packet, then the processor 210 logs the request in log file 236 and terminates the request by not responding to the computer 11. The computer 11 is thus provided with no information that could be used by an attacker to attempt to access the resource. The computer 11 further logs the request in the log file 236. The processor 210 can log the IP address of the computer 11 requesting access, the time of receipt of the request, the resource for which access was attempted by the request computer 11, the realm identifier (if any) of the request computer 11, and possibly other data from the received SYN packet, in order to provide a record of the access attempt. The logged data can be used for a variety of purposes. For example, the application 222 can be such as to prohibit further attempts after a determined number of failed access attempts are received by the enforcement computer 28. The logged data can also be used for forensics, analysis of computer network vulnerability, forensics, and possibly prosecution of an attacker, and possibly other purposes.

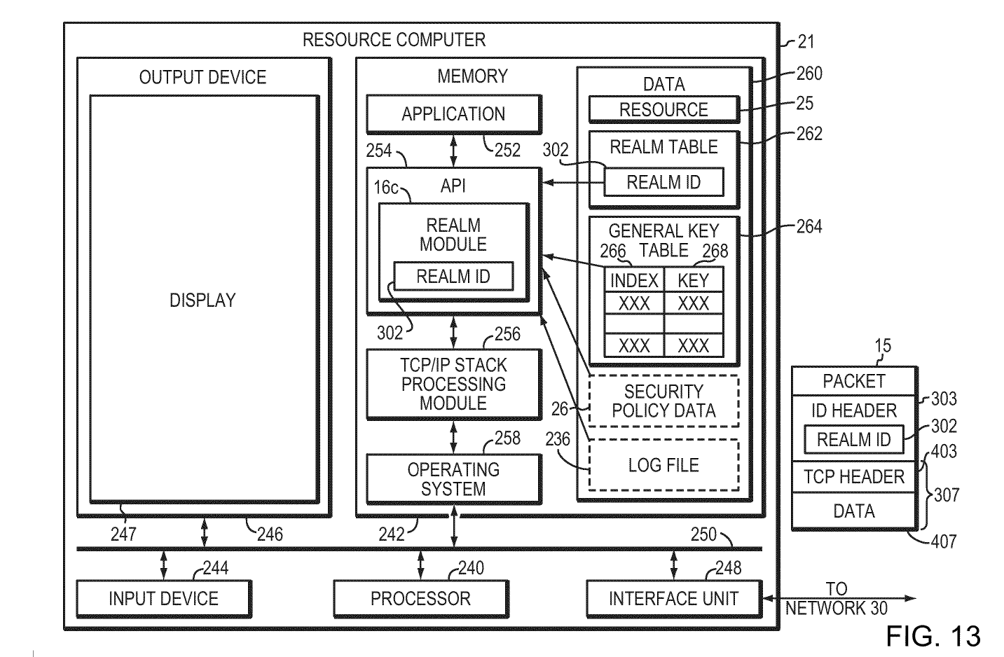

FIG. 13 is a block diagram of an embodiment of the resource computer 21 comprising a processor 240, a memory 242, an input device 244, an output device 246, an interface unit 248, and a bus 250 coupling the foregoing elements together. The memory 242 stores a resource 25, security policy data 26, a realm table 262, and a general key table 264. The realm table 262 stores a realm identifier (ID) 302. The general key table 264 stores indexes 266 in correspondence with keys 268. The resource computer 21 is coupled to receive the packet 15 requesting access to a resource 25 after release by the enforcement node 28. The resource computer 21 receives the packet 248 (e.g., a TCP/IP SYN packet) at the interface unit 248, and the processor 240 executes the operating system 258 to obtain the received packet 15 via the bus 250 and to store such packet in the TCP/IP stack processing module 256. Because the packet has already been checked under the security policy of the realm to which the resource computer 21 belongs, it is not generally necessary for the resource computer 21 to again apply the realm security policy if the enforcement node 28 is located at a position, such as the gateway to the Internet, which prevents unauthorized intrusion to the resource computer 21. However, it is an option that security policy can be applied at the resource computer 21. This can be done in a manner similar to that described with respect to the enforcement node 28.

The processor 240 executes the realm module 16c of the API 254, which causes the processor 240 to retrieve from the memory 242 via the bus 250 the realm identifier 302 of the realm module 16c and the realm identifier 302 stored as data 260. The processor 240 compares the realm identifier 302 of the realm module 16c and the realm identifier 302 stored as data 260. If the two identifiers do not match, an attempt has been made to run the realm module 16c on a computer other than that in which it was originally installed, and further execution of the realm module 16c by the processor 240 prevents retrieval of the requested resource 25. Conversely, if the realm identifier 302 of the realm module 16c matches the realm identifier 302 stored as data 260, then the realm module 16c continues to process the received packet requesting access to the resource 25.

The processor 240 can execute the realm module 16c to retrieve the GKI 412 from the urgent pointer field of the TCP packet header. The processor 240 retrieves the general key 266 corresponding to the GKI 412 from the table 264 and uses this key to decrypt the sequence number and acknowledgement number fields of the TCP packet header. The processor 240 compares the GKI 412 constituting the last eight bits of the decrypted sequence number field with the GKI 412 from the urgent pointer field. If the two are not the same, then the processor 240 halts further processing of the packet and transmits information regarding the packet to the enforcement node 28 to record the fact that a hijacked connection has been detected. Conversely, if the GKI 412 from the urgent pointer field of the packet matches the GKI 412 decrypted from the sequence number field of the packet, then the processor 240 proceeds with processing the packet.

The processor 240 examines the request in the data field of the packet, and extracts the request and relevant attributes and commands, and provides same to the application 252. In response to receiving the request and relevant attributes, the application 252 can react differently, depending upon the nature of the resource 25. For example, if the resource is in the form of data, the application 252 uses the request and any attribute, parameter, metadata, etc. associated with it in order to generate a query to retrieve the resource 25 from the memory 242. It should be understood that there could be, and normally is, much more data than is shown in FIG. 13 so that a query with one or more search criteria (e.g., an attribute, parameter, metadata, etc.) may be necessary to specify the requested data. Depending upon the nature of the request, the retrieved data resource can be provided to the computer 11 via the enforcement node 28 and network 30, or to an altogether different node, depending upon the nature of the request. If the resource 25 is in the form of a program, the application 252 can cause same to be interpreted or compiled (if not already in executable form) and executed by the processor 240 or another node designated by the request or execution of the program. If so programmed, output generated by the execution of the resource 25 on the processor 240 (or processor of another designated node) can be provided to the request computer 11 via the computer 28 and the TCP/IP connection established with such computer.

In an embodiment it is an option, rather than to have the enforcement computer 28 apply the security policy of the realm including the resource computer, that the resource computer 21 can apply the security policy itself. In addition, there may be some circumstances in which it would be advantageous for the enforcement node 28 and the resource computer 21 to each apply realm security policy. Accordingly, the security policy data 26 is indicated in broken line as part of the data in the memory 242 to signify that it is an optional feature of the resource computer 21. If the resource computer 21 applies security policy, then the processor 240 compares the realm identifier 302 contained within the packet with the realm identifier 302 it retrieves from its memory 260. If the two do not match, the processor 240 applies security policy on the basis that the realm of the requesting node is different than the realm of the resource node 21. Conversely, if the realm identifiers 302 match, then the processor 240 applies the data 26 defining the security policy of the realm hosting the resource 25 on the basis that the requesting node 11 and the resource node 21 are in the same realm. In addition to using the comparison of the realm originating a request to access a resource with the realm hosting the resource, the processor 240 can execute the realm module 16c to apply security policy on the basis of the user indicated by the UID 408 and the request-originating system (i.e., node) identified by the SID 410 which it decrypts from the received packet. Assuming that the security policy does not permit the request node 11 to access the resource node 21 (whether on the basis of the realm, user, system, or a combination of the same), further execution of the realm module 16c causes the processor 240 to halt further processing of the packet and to forward information regarding the request, such as the source address, destination address, resource, time of request, etc., to the enforcement node 28 for logging. Alternatively, the resource node 21 can itself log the request.

Conversely, assuming the request node 11 is permitted access to the resource 25 under the security policy data 26 applied by the resource computer 21, the processor 240 retrieves the resource 25 and provides access to same to the request computer 11. More specifically, if the resource 25 is in the form of data, then the resource node 21 can transmit the same to the request node 11 via network 30. Alternatively, if the resource 25 is a program, the resource computer 21 can load, compile or interpret such program (if necessary), and execute the same. Depending upon the program, output data generated by the resource node 21 can be transmitted to the request computer 11 or other node.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising the step of, at a first node, including a realm identifier within a field of a packet, the realm identifier identifying a security realm associated with the first node, the packet operating as a request for accessing a resource associated with a second node.

2. The method of claim 1, further comprising the step of transmitting the packet including the realm identifier from the first node to the second node hosting the resource via a network.

3. The method of claim 2, further comprising the steps of:
receiving the packet at the second node;
comparing the realm identifier from the packet header with a realm identifier of the second node; and
applying a security policy to the packet to control access to the resource based on the results of the comparison.

4. The method of claim 1, wherein the step of including a realm identifier within a field of a packet further comprises including the realm identifier in header of an Internet Protocol (IP) packet.

5. The method of claim 4, wherein the step of including a realm identifier within a field of a packet further comprises including the realm identifier with one or more fields of a Transmission Control Protocol/Internet Protocol (TCP/IP) SYN packet for initiating a network connection.

6. The method of claim 1, wherein the step of including a realm identifier within a field of a packet further comprises the steps of:
encrypting data identifying the first node and a user of the first node using a key;
including the encrypted data in at least one field of the header of the packet; and
including the index identifying the key in an additional field of the packet header.

7. The method of claim 6, wherein the step of including the encrypted data in at least one field of the header of the packet further comprises including the encrypted data within the sequence number and acknowledgement number fields of a transmission control protocol (TCP) portion of the header of the packet.

8. The method of claim 1, further comprising the step of retrieving the realm identifier from the first node.

9. The method of claim 8, further comprising the steps of:
receiving the packet at the second node;
comparing the realm identifier from the packet header with a realm identifier of the second node; and
applying a security policy to the packet to control access to the resource based on the results of the comparison.

10. A system for providing controlled access to a network based resource, the system comprising:
a first node adapted to:
execute a realm module receiving a request to access a resource from an application running on the first node;
retrieve a realm identifier associated with the first node;
include the realm identifier in a header of a packet; and
release the packet for transmission to a second node; and
the second node being adapted to:
receive the packet; and
enforce a security policy for access to the resource based at least in part on the value of the realm identifier.

11. The system of claim 10, wherein the request designates a resource that includes either or both of data and a program.

12. The system of claim 10, wherein the first node is a computer.

13. The system of claim 10, wherein the packet is a Transmission Control Protocol/Internet Protocol (TCP/IP) packet.

14. The system of claim 10, wherein the packet is a TCP/IP SYN packet.

15. A medium storing a program that when executed by a first node causes the first node to perform the following steps:
receive a request to access a resource from an application running on the first node;
retrieve a realm identifier of the first node;
include the realm identifier in a header of a packet; and
release the packet for transmission to a second node enforcing security policy for access to the resource.

16. The medium of claim 15, wherein the resource comprises at least one of data and a program.

17. The medium of claim 15, wherein the first node is a computer.

18. The medium of claim 15, wherein the packet is a transmission control protocol/Internet protocol (TCP/IP) packet.

19. The medium of claim 15, wherein the packet is a TCP/IP SYN packet.

20. The medium of claim 15, wherein the packet is an IP packet.
